(19) United States
(12) Patent Application Publication
(10) Pub. No.: US 2026/0212378 A1
(43) Pub. Date: Jul. 23, 2026

(54) A SYSTEM FOR CALCULATING THE TIME OF DEVICE CHANGE

(71) Applicant: TURKCELL TEKNOLOJI ARASTIRMA VE GELISTIRME ANONIM SIRKETI, Istanbul (TR)

(72) Inventors: Emre DONAT, Istanbul (TR); Samet KELES, Istanbul (TR)

(73) Assignee: TURKCELL TEKNOLOJI ARASTIRMA VE GELISTIRME ANONIM SIRKETI, Istanbul (TR)

(21) Appl. No.: 19/138,615

(22) PCT Filed: Dec. 12, 2023
(86) PCT No.: PCT/TR2023/051526

§ 371 Date: Jun. 12, 2025

(30) Foreign Application Priority Data
Dec. 12, 2022 (TR) 2022/019009

(51) Int. Cl. G06Q 30/0203; G06Q 30/0201

(52) U.S. Cl. CPC G06Q 30/0203; G06Q 30/02011

(57) ABSTRACT

The present invention relates to a system (1) which enables to calculate the frequency of device change and the time of device change by using the campaign and device information of corporate customers who get service from a telecom operator and use voice, data and SMS.

### TECHNICAL FIELD

The present invention relates to a system which enables to calculate the frequency of device change and the time of device change by using the campaign and device information of corporate customers who get service from a telecom operator and use voice, data and SMS.

### BACKGROUND OF THE INVENTION

GSM operators provide services to their subscribers through packages which generally include voice, data and SMS usage and they also aim to sell devices such as smartphone, tablet and computer. Packages containing voice, data and SMS usage are provided individually and corporately. Further emphasis is put on corporate customers than individual customers, visits are made by field teams, and it is aimed to make new contracts and sales. A field representative can only access the information about whether s/he has sold a device to the corporate customer s/he was interested in, only when s/he queries the information of the said corporate customer. Therefore, today there is a need for solutions which will enable corporate customers—particularly those who sell devices under contracts—to sell new devices by predicting device changes.

The Korean patent document no. KR102280223B1, an application included in the state of the art, discloses a system and method for supporting big data-based product purchase decision. In the invention, information which may help the user who wants to purchase a product in decision making is analyzed. The method included in the invention comprises the steps of constructing a trend information database, a product information database and a customer information database; receiving user information from a user terminal accessed through a network; receiving a purchase condition including at least an event type, quantity, and budget from the user terminal; providing recommended product information to the user terminal; receiving a purchase request; and providing a review report to the user terminal. The method of the invention comprises the steps of receiving user information, login information from a user terminal accessed through a network; receiving purchase conditions including at least event type, quantity, and amount information; selecting the products matching the purchase condition based on the trend information and the product information which are stored in the database; generating the recommended product information based on the selected product information and sending it to the user terminal; receiving the purchase request from the user device and creating a final report related to the purchase request; and transmitting the report to the user terminal.

### SUMMARY OF THE INVENTION

An objective of the present invention is to realize a system which enables to calculate the frequency of device change and the time of device change by using the campaign and device information of corporate customers who get service from a telecom operator and use voice, data and SMS.

### DETAILED DESCRIPTION OF THE INVENTION

“A System for Calculating the Time of Device Change” realized to fulfil the objective of the present invention is shown in the figure attached, in which:

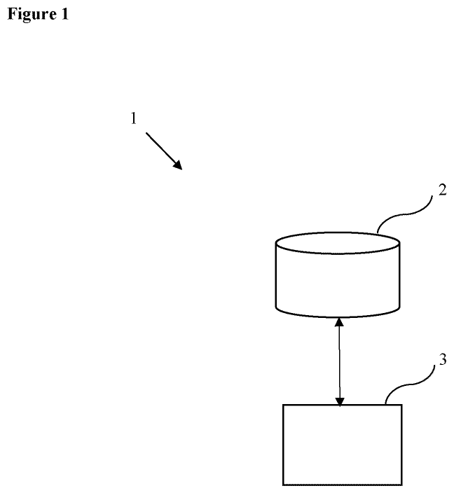

FIG. 1 is a schematic view of the inventive system.

The components illustrated in the figure are individually numbered, where the numbers refer to the following:
1. System
2. Database
3. Server

The inventive system (1) for calculating the frequency of device change and the of device change of corporate customers—who get service from a telecom operator and have contracted devices—comprises
at least one database (2) which is configured to store GSM numbers of corporate customers, customer/company names, customer number, campaign information, device IMEI information, device information of corporate customers, launch date and network signal date, segment information of customers, customer authorized information; and
at least one server (3) which is configured to be in communication with the database (2) and to realize data exchange with the database (2); to process the data included in the database (2); to calculate how often the corporate customers who are registered in the database (2) change their device; then to classify corporate customers according to the contract expiration period in accordance with their contract information; then to ensure that the time of device change is calculated considering the depreciation period of the smartphone by using signal date of device, launch date of phone, commencement date of contract; and to calculate at least information of how many contracted devices the customer has, how many of them are due for change, the brand tendency of customer, the frequency of phone change, and the total number of devices used on the lines, on customer basis in quantity; and to share it with the customer.

The database (2) included in the inventive system (1) is in communication with the server (3) and configured to realize data exchange with the server (3). In one preferred embodiment of the invention, the database (2) is configured to store company name, GSM numbers, customer number information of active lines of corporate customers. The database (2) is configured to store information campaign details comprising contract status and contract date of corporate customers. The database (2) is configured to store brand, model, type, launch date information of devices included on the corporate line and information on the date when they first gave signal to the network. The database (2) is configured to store information of segment and sales managers of customers in order to inform customer representatives that it is time to change the device.

The server (3) included in the inventive system (1) is configured to be in communication with the database (2) and to realize data exchange. The server (3) is configured to calculate how often the customers included in the database (2) change their device on the basis of line, by using the company details wherein contract status and contract date information of customers are included. The server (3) is configured to exclude changes made within an assigned period of time when processing campaign data. Thereby, it is ensured that changes which occur in cases such as customer-related malfunctions are prevented from generating deviation in calculation of change habit.

The server (3) included in the inventive system (1) is configured to analyze campaign detail data, wherein contract status and contract date information are included, from the data in the database (2) and to classify the customers according to the contract expiration period. The server (3) is configured to share the contract expiration period with customer managers together with the information of device change. The server (3) is configured to calculate the depreciation period of devices by analysing brand, model, type, launch date information of the devices and the information of date they first signaled to the network and to calculate the time of device change by using the depreciation information. All times of device change calculated by the server (3) according to depreciation data may all be different from each other. Lastly, the server (3) is configured to calculate how many contracted devices the corporate customers have, how many of them are due for change, the brand tendency of customer, the frequency of phone change, and the total number of devices used on the lines, on customer basis in quantity and to share it with the customer via a table, by using the campaign and device information analyzed. Thereby, since the customer representative knows which corporate customers are liable to change their device, they can increase the income of the GSM operator by offering new contracts to the related customers.

With the inventive system (1), an income increasing effect is provided on the operator side by creating opportunities for selling phones to corporate customers. On the other hand, phones which are due for change can be used for refurbishment purposes.

The inventive system (1) submit information and approval comprising the principles of data privacy to the user and it operates within the scope of the Personal Data Protection Law (KVKK).

Within these basic concepts; it is possible to develop a wide variety of embodiments of the inventive “System (1) for Calculating the Time of Device Change”; the invention cannot be limited to examples disclosed herein and it is essentially according to claims.

1. A system (1) for calculating the frequency of device change and the time of device change of corporate customers—who get service from a telecom operator and have contracted devices—characterized by
at least one database (2) which is configured to store GSM numbers of corporate customers, customer/company names, customer number, campaign information, device IMEI information, device information of corporate customers, launch date and network signal date, segment information of customers, customer authorized information; and
at least one server (3) which is configured to be in communication with the database (2) and to realize data exchange with the database (2); to process the data included in the database (2); to calculate how often the corporate customers who are registered in the database (2) change their device; then to classify corporate customers according to the contract expiration period in accordance with their contract information; then to ensure that the time of device change is calculated considering the depreciation period of the smartphone by using signal date of device, launch date of phone, commencement date of contract; and to calculate at least information of how many contracted devices the customer has, how many of them are due for change, the brand tendency of customer, the frequency of phone change, and the total number of devices used on the lines, on customer basis in quantity; and to share it with the customer.

2. A system (1) according to claim 1; characterized by the database (2) which is in communication with the server (3) and configured to realize data exchange with the server (3).

3. A system (1) according to claim 1; characterized by the database (2) which is configured to store company name, GSM numbers, customer number information of active lines of corporate customers.

4. A system (1) according to claim 1; characterized by the database (2) which is configured to store information campaign details comprising contract status and contract date of corporate customers.

5. A system (1) according to claim 1; characterized by the database (2) which is configured to store brand, model, type, launch date information of devices included on the corporate line and information on the date when they first gave signal to the network.

6. A system (1) according to claim 1; characterized by the database (2) which is configured to store information of segment and sales managers of customers in order to inform customer representatives that it is time to change the device.

7. A system (1) according to claim 1; characterized by the server (3) which is configured to calculate how often the customers included in the database (2) change their device on the basis of line, by using the company details wherein contract status and contract date information of customers are included.

8. A system (1) according to claim 1; characterized by the server (3) which is configured to analyze campaign detail data, wherein contract status and contract date information are included, from the data in the database (2) and to classify the customers according to the contract expiration period.

9. A system (1) according to claim 1; characterized by the server (3) which is configured to calculate the depreciation period of devices by analysing brand, model, type, launch date information of the devices and the information of date they first signaled to the network and to calculate the time of device change by using the depreciation information.

10. A system (1) according to claim 1; characterized by the server (3) which is configured to calculate how many contracted devices the corporate customers have, how many of them are due for change, the brand tendency of customer, the frequency of phone change, and the total number of devices used on the lines, on customer basis in quantity and to share it with the customer via a table, by using the campaign and device information analyzed.
